(19) United States
(12) Patent Application Publication
(10) Pub. No.: US 2002/0113712 A1
(43) Pub. Date: Aug. 22, 2002

(54) Earthquake warning apparatus

(76) Inventor: Peyman Makhfi, Teheran (IR)

Correspondence Address: Lawrence G. Fridman, Silber & Fridman, 66 Mount Prospect Ave., Clifton, NJ, 07013-1918, US

(21) Appl. No.: 09/946,151

(22) Filed: Sep. 4, 2001

(30) Foreign Application Priority Data
Sep. 1, 2000 (DE) 100 43 555.6

(51) Int. Cl. G01W 1/00

(52) U.S. Cl. 340/601; 340/540

(57) ABSTRACT

In an earthquake warning apparatus with a signal generator for optical or acoustical signals, a voltage source having two contact bodies is provided, the contact bodies being spaced from each other. At least one of these contact bodies is movable, whereby the contact bodies make at least short-time contact, when the apparatus subjected to vibrations. This triggers a signal of the signal generator. The first contact body is a freely suspended metal chain connected to one terminal of the voltage source. A weight of metal is attached to the lower end of the chain. The weight is circular in cross section and is tapered towards the top. The other contact body is a hollow cylinder of metal which is connected to the other terminal of the voltage source. The hollow cylinder surrounds the chain. The alarm may be triggered for a limited time interval or indefinitely.

### BACKGROUND OF THE INVENTION

The invention relates to an earthquake warning apparatus. Such apparatus is to generate optical or acoustical signals, if vibrations or shaking of a certain strength indicate an earthquake.

Earthquake warning devices are used to protect the inhabitants of in earthquake-prone areas. Often, inhabitants if earthquake-prone areas are surprised by earthquakes while sleeping. In these cases, there is often not sufficient time, for example, to leave a collapsing house. Therefore it is essential to early warn people of an earthquake.

### DISCLOSURE OF THE INVENTION

It is an object of the invention to provide an earthquake warning apparatus which, in earthquake-prone areas, detects an earthquake, in a simple way, and warns the inhabitants.

To this end, a voltage source with two spaced contact bodies is provided. At least one of these contact bodies is movable, such that the contact bodies make at least short-time contact, when the apparatus is subjected to vibrations or shaking. Thereby, a signal of a signal generator is triggered. An alarm is initiated thereby, as soon as vibrations for example due to an earthquake occur. The inhabitants are warned thereby.

In a preferred embodiment of the invention, a first contact body comprises a freely suspended metal chain connected to one terminal of the voltage source. Such a metal chaine is able to swing freely and, therefore, is a particularly vibration- or shaking-sensitive contact body. The movable contact body may, however, have other shapes such as rods, balls or the like.

A weight may be attached to the lower end of the chain. This ensures, that the chain extends straight downwards. The weight may be of metal and may be conductively connected with the chain. Then the weight serves to contact the other contact body. The dimensions of the weight may be adapted to those of the other contact body such that contact is established also, when minor vibrations occur.

In a prefered embodiment of the invention, the weight is circular in cross section and is tapered towards the top. The other contact body is a hollow cylinder of metal, which is connected to the other terminal of the voltage source. The hollow cylinder is arranged around the chain. Thereby, each movement of the chain in any radial direction results in contact with the hollow cylinder, provided the amplitude exceeds a certain, preselected value. Alternatively, a swinging hollow cylinder may be arranged around a stationary rod.

Preferably, the hollow cylinder is insulated from the chain at the upper end of the hollow cylinder. Then contact is established only, when the chain swings at its lower end where the amplitude is maximal. Faulty contacts are avoided.

In a particularly preferred embodiment, the hollow cylinder consists of two coaxial parts which are interconnected by a screw thread. If the lower cylinder portion is slightly screwed out of the upper cylinder portion, the total length of the hollow cylinder is increased, and the lower edge thereof is closer to the weight which is attached to the lower end of the chain. In this way, the sensitivity can be adjusted through the spacing between the two contact bodies. This adjustment of the sensitivity can be carried out, in a simple way, by selecting, at first, a very sensitive setting. If the alarm is then triggered by harmless vibration or shaking such as those caused by a passing car or by a person walking through the room, the sensitivity will be somewhat reduced by slightly increasing the spacing between the contact bodies. This is effected by rotating the second cylinder portion to increase the total length of the hollow cylinder. This procedure is repeated until no faulty alarm is triggered anymore.

The warning apparatus may be combined with a clock such as a wall clock. The signal generator, preferably, generates an electric alarm as, for example, known from an alarm clock. However, also a mechanical signal generating means may be used which is triggered by an electric pulse. Prefereably, the electric alarm is powered by the voltage source, to which the contact bodies are connected.

In a particularly preferred variant, the alarm is triggered for a limited time only, in the case of a short-time vibration. In certain cases, a faulty alarm is triggered, even when the sensitivity is correctly set. The duration of such a faulty alarm can be limited by an appropriate circuit. Such a circuit may, for example, limit each alarm, which has been triggered by a single contact making within a selected time interval, to a selected duration. If, however, contact is made several times within the selected time interval, the alarm will not be switched off again.

The hollow cylinder can be mounted for adjusment of its orientation in space. If, for example, the earthquake warning apparatus with an attachment device for the hollow cylinder is hung to a not exactly vertical wall, the hollow cylinder has to be adjustable relative to the agent device such that it continues to hang exactly vertical, as, otherwise, it would make contact with the chain or the weight suspended therefrom.

An embodiment of the invention will now be described with reference to the accompanying drawings.

### BRIEF DESCRIPTION OF THE DRAWINGS

FIG. 1 is a front view of an earthquake warning apparatus in combination with a wall clock.

FIG. 2 is a rear view of an earthquake warning apparatus in combination with a wall clock.

FIG. 3 shows an earthquake warning apparatus in detail.

FIG. 4 is a block diagram and illustrates schematically the circuit for triggering the alarm

### DESCRIPTION OF A PREFERRED EMBODIMENT

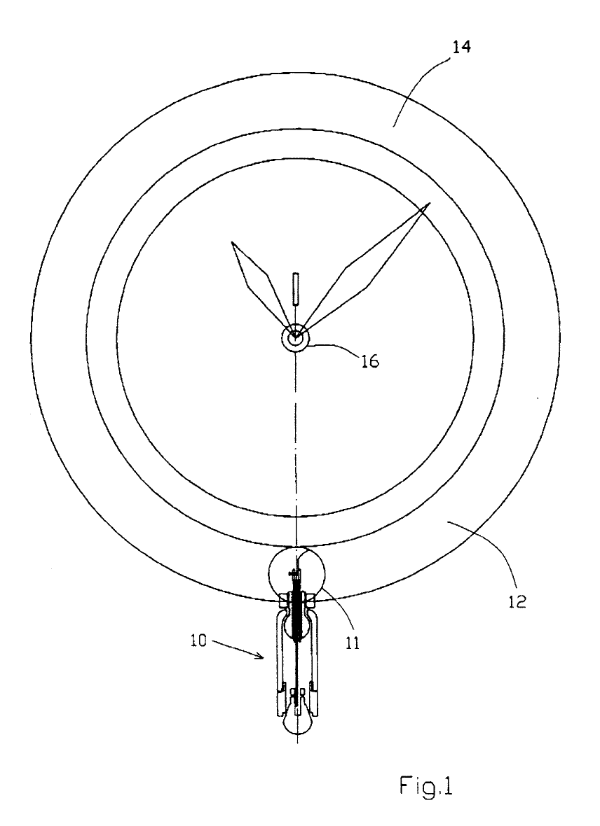

Referring to FIG. 1, numeral 10 designates an earthquake warning apparatus, which is mounted on the lower end of a clock 12. The clock 12 is a wall clock having a large clock face 14 and a hand assembly 16. In the illustration, a circular piece 11 of the clock face is removed to better show the earthquake warning apparatus 10.

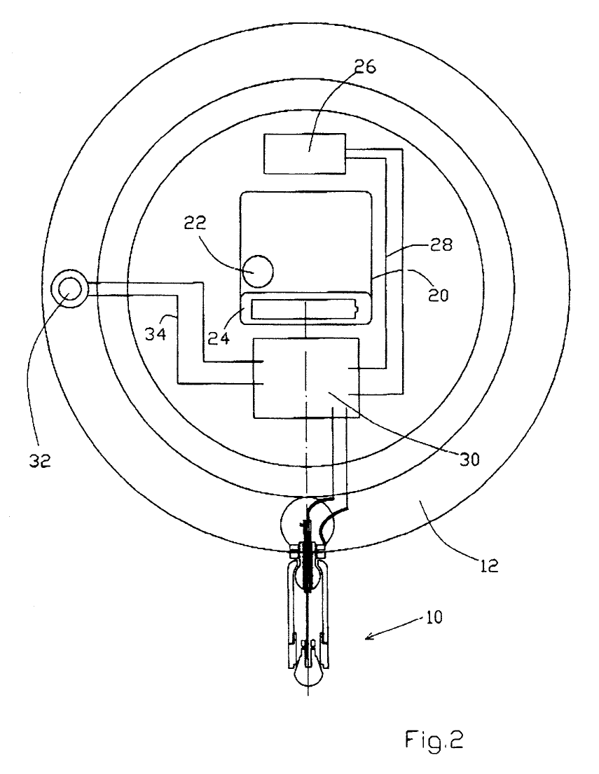

FIG. 2 shows the rear side of the clock 12 and of the earth quake warning apparatus 10. Usually, the drive mechanism 20 for the hand assembly 16 with setting knob 22 and battery as power supply are mounted on the rear side of the clock face.

A further battery 26 is connected through supply lines 28 with an electronic circuit 30. The electronic circuit 30 is mounted on a printed circuit board which is also mounted on the rear side of the clock face 14. An electric alarm in the form of a buzzer 32 is energized through the electronic circuit and the supply lines.

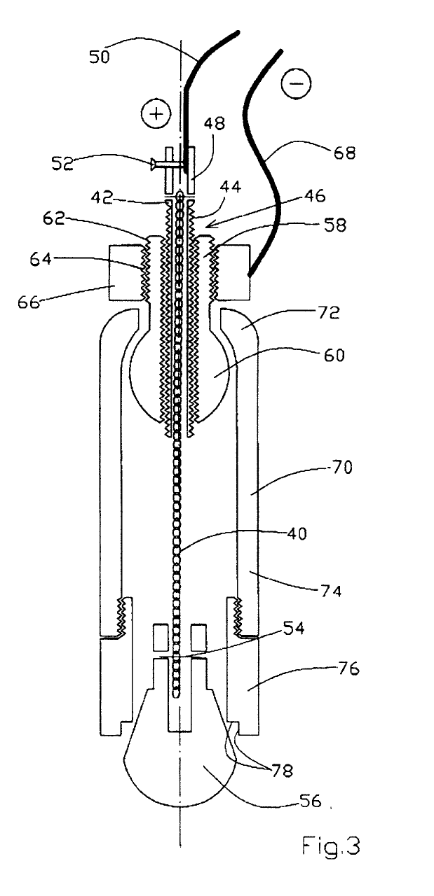

The earthquake warning apparatus 10 is again illustrated in FIG. 3 in greater detail. A chain 40 of metal is attached to a metal disc 43, which lies horizontal between a cylinder 44 externally threaded at 46 and a metallic attachment cylinder 48. The cylinder 44 consists of an electrically insulating material. A connecting cable 50 is connected through the electronic circuit 30 to the plus terminal of a battery (not shown). The cable 50 extends into the attachment cylinder 48 and is clamped there by means of a screw 52, which extends through a bore in the cylinder wall. Thus the chain 40 is connected through disc 42, the attachment cylinder 48 and the cable 50 to the plus terminal of a battery.

The chain 40 is freely suspended and extends vertically downwards. The externally threaded electrically insulated cylinder 44 extends along part of the chain length around the chain 40. Another disc 54 is attached to the lower end of the chain 40. Also the disc 54 is made of metal and is electrically conductive. Together with the disc 54, a weight 56 is attached to the chain 40. The weight 56 is of metal and electrically conductive.

A further cylinder 58 made of metal is screwed on the external thread 46 of the insulating cylinder 44. The cylinder 58 is provided with an external thread 62. With this external thread 62, the cylinder 58 is screwed into an internal thread 64 of an attachment ring 66 of metal. The attachment ring 66 is firmly connected with the edge of the clock face 14 of the clock 12. The attachment ring is connected to the minus terminal of a battery the rough a connecting cable 68.

The cylinder 58 flares at its lower end to form a ball 60. A metallic hollow cylinder 70 having a spherical internal profile is movably mounted at its upper end 72. The hollow cylinder 70 extends over the length of the chain 40 and partly over the length of the weight.

The hollow cylinder 70 consists of two coaxial parts 74 and 76, which are screwed with each other through threads. The total length of the hollow cylinder 70 can be varied by rotating the two parts 74 and 76 relative to each other. The weight 56 is circular in horizontal cross section and tapered towards the top. The radius of the hollow cylinder 70 and of the weight 56 is selected such that, when the length of the hollow cylinder 70 is varied, the radial spacing between the weight 56 and the inner edge 78 of the hollow cylinder is varied accordingly.

When the weight 56 is moved due to a vibration or shaking, it will touch the inner edge of the hollow cylinder, if the amplitude is sufficient. The weight 56 is connected to the plus terminal of the battery or a positive terminal of circuit 30, respectively, through the chain 40 and the cylinder 48. The hollow cylinder 70 is connected to the negative terminal of the circuit 30 through the ball 60 and the ring 66. By establishing contact between the two terminals, a signal is transmitted by the circuit 30 to the buzzer 32 to trigger an alarm.

By appropriate design of the circuit, an on-off alarm is triggered which is limited to five alarm signals, if the vibration makes one contact in a time interval of one second. The alarm is unlimited, if contact between weight 56 and hollow cylinder 70 is made for an extended time interval within one second, or if such contact is made repeatedly within one second.

Depending on the spacing between weight 56 and hollow cylinder 70, contact may be made already by small vibrations, if, for example, somebody walks through the room or if a vehicle passes by. In this case, the cylinder portion 76 can be screwed further into the cylinder portion 74, whereby the spacing between weight 56 and hollow cylinder 70 is increased. Then, a larger oscillation amplitude of the weight is required to establish contact. In this way, the sensitivity of the assembly is reduced. This procedure can be repeated, until the sensitivity is adapted to the local situation.

When installing the assembly, care has to be taken that the hollow cylinder 70 extends exactly vertically around the chain. This is necessary to ensure direction-independent sensitivity. Variation of the orientation of the hollow cylinder 70 can be achieved by movement about the ball 60.

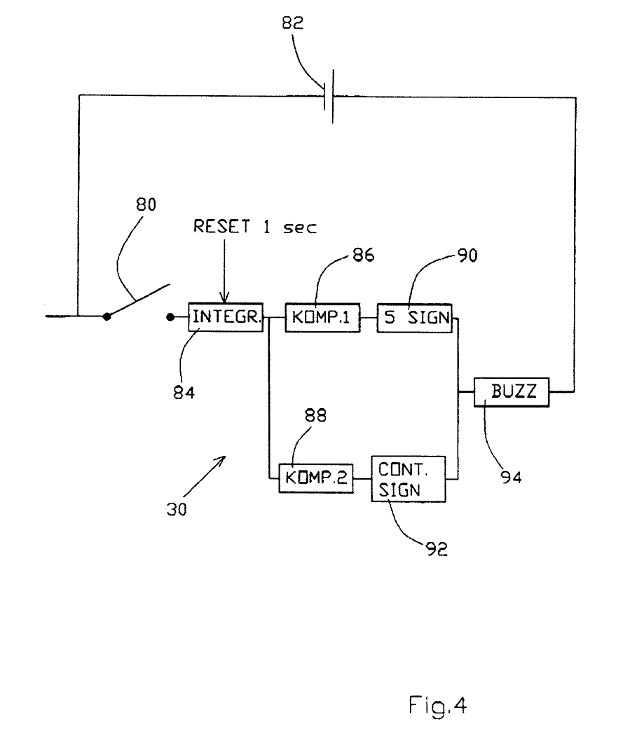

FIG. 4 ist a schematic block diagram and illustrates, as an example only, the circuit for triggering the alarm.

The two contact elements making contact upon heavy vibrations or shaking are illustrated as switch 80. Switch 80, through circuit 30, is connected across a battery 82. The current flowing through switch 8O, when contact is made between the contact elements, is integrated by integrator 84. Integrator 84 is reset every second. The output from integrator 84 is applied, in parallel, to two comparators 86 and 88. The first comparator 86 responds, when the integrator 84 provides a relatively low output corresponding to one single making of contact between the contact elements. The second comparator 88 responds, when a contact is made several times, each making of the contact providing an input pulse at the integrator. It does not yet respond after a single making of contact between the contact elements. The first comparator 86 triggers a first signal generator 90, which provides a train of five signal pulses. The second comparator 88 triggers a second signal generator 92, which provides a continuous output signal. The output signals are applied to a buzzer 94.

I claim:

1. An earthquake warning apparatus with signal generating means for generating warning signals in the case of an earthquake, said signal generating means comprising: voltage source means having terminal means and a pair of spaced contact bodies connected to said terminal means, at least one of said contact bodies being movable to establish at least short-time contact with the other one of said contact bodies, if said apparatus is subjected to vibrations, and means for triggering a warning signal by said signal generating means responsive to contact between said contact bodies.

2. An earthquake warning apparatus, wherein said movable contact body comprises a metal chain freely suspended at one end thereof and connected, at said one end, to one of said terminal means.

3. An earthquake warning apparatus as claimed in claim 2, wherein a weight is attached to the lower end of said chain.

4. An earthquake warning apparatus as claimed in claim 3, wherein said weight consists of metal and is conductively connected to said chain.

5. An earthquake warning apparatus as claimed in claim 4, wherein said weight is circular in cross section and tapered towards the top.

6. An earthquake warning apparatus as claimed in claim 2, wherein said other contact body is a hollow cylinder element of metal, said hollow cylinder element being connected to the other one of said terminal means.

7. An earthquake warning apparatus as claimed in claim 6, wherein said hollow cylinder element is arranged around said chain.

8. An earthquake warning apparatus as claimed in claim 7, wherein said hollow cylinder element has a lower portion and an upper end portion, said upper end portion comprising means for electrically insulating said end portion from said chain.

9. An earthquake warning apparatus as claimed in claim 6, wherein said hollow cylinder element consists of two coaxial hollow-cylindrical parts interconnected by screw thread means.

10. An earthquake warning apparatus as claimed in claim 6 and further comprising means for adjusting orientation of said hollow cylinder.

11. An earthquake warning apparatus as claimed in claim 1, said apparatus being combined with a clock.

12. An earthquake warning apparatus as claimed in claim 11, wherein said clock is a wall clock.

13. An earthquake warning apparatus as claimed in claim 1, wherein said signal generating means comprise means for generating an electric alarm.

14. An earthquake wag apparatus as claimed in claim 13, wherein said alarm generating means are powered from said voltage source means through said contact bodies.

15. An earthquake warning apparatus as claimed in claim 13, wherein said alarm generating means are designed to generate an alarm for a limited time only, if said vibrations are of short duration, and to generate an alarm for an unlimited time, if said vibrations continue for an extended period of time.
